(19) United States
(12) Patent Application Publication
(10) Pub. No.: US 2009/0229677 A1
(43) Pub. Date: Sep. 17, 2009

(54) Pump connector device for different valves

(76) Inventor: Lopin Wang, Taichung (TW)

Correspondence Address: CHARLES E. BAXLEY, ESQUIRE, 90 JOHN STREET, SUITE 309, NEW YORK, NY, 10038, US

(21) Appl. No.: 12/075,595

(22) Filed: Mar. 11, 2008

(51) Int. Cl. F16K 15/20

(52) U.S. Cl. 137/231

(57) ABSTRACT

A pump connector device includes two or more sleeves engaged into a housing for receiving inflation valves, a mobile member engaged in the housing for compressing the sleeves to grasp the inflation valves, two or more valve elements engaged into the sleeves for engaging with the inflation valves, a casing slidably engaged in the housing and having a conduit and two or more spaces for receiving the valve elements and for forcing the mobile member to compress the sleeves to grasp the inflation valves, the inflation valves may disengage the valve elements from the mobile member for allowing the pressurized air to flow into the mobile member when the mobile member and the sleeves are compressed by the casing.

### BACKGROUND OF THE INVENTION

1. Field of the Invention

The present invention relates to an air valve connecting head or device, and more particularly to a pump connector device including a simplified structure for easily connecting to different inflation valves of U.S. type and French type valves and/or the other nozzles and for being easily operated by the users.

2. Description of the Prior Art

Typical air valve connecting heads or devices or pump connector devices comprise two fitting ports formed in two opposite ends of a valve housing for receiving or engaging with different inflation valves, such as the U.S. type valves and the French type valves, and for inflating the balls, the inner tires of the bicycles or the motorcycles or the vehicles.

For example, U.S. Pat. No. 5,645,100 to Chuang et al. discloses one of the typical air valve connecting heads or hand-held air pumps comprising a pipe, and two gaskets and a plug member engaged in the pipe, in which the gaskets may be provided for engaging with different inflation valves.

However, the typical hand pumps have no valve elements engaged into the gaskets and/or the plug member for engaging with the inflation valves such that the inflation valves may not be effectively inflated with or by the typical hand pumps.

U.S. Pat. No. 5,749,392 to Glotin disclose another typical pump connector device comprising a mobile member slidably engaged in a housing and containing at least two different connectors for inflating different pneumatic tires having different type valves.

However, no valve elements have been provided and engaged into the typical pump connector device for engaging with the inflation valves such that the inflation valves may not be effectively inflated with or by the typical hand pumps.

U.S. Pat. No. 6,289,920 to the present inventor, Wang discloses a further typical air pump nozzle comprising a fitting port or holding mouth formed in a housing for selectively and changeably engaging with different inflation valves.

However, the typical air pump nozzle may only be used for engaging with only a single inflation valve one at a time, but may not be used for engaging with two or more inflation valves simultaneously.

U.S. Pat. No. 6,843,270 to Wang discloses a still further typical air valve connecting head for the hand-held air pump and comprising a housing having a central chamber and two side chambers for receiving three connector assemblies and for selectively or alternatively or changeably engaging with different inflation valves.

However, the typical air valve connecting head comprises no valve elements provided and engaged in the typical pump connector device for engaging with the inflation valves such that the inflation valves may not be effectively inflated with or by the typical hand pumps.

The present invention has arisen to mitigate and/or obviate the afore-described disadvantages of the conventional pump connector devices.

### SUMMARY OF THE INVENTION

The primary objective of the present invention is to provide a pump connector device including a simplified structure for easily connecting to different inflation valves of U.S. type and French type valves and/or the other nozzles and for being easily operated with or by the users.

In accordance with one aspect of the invention, there is provided a pump connector device comprising a housing including a chamber formed therein, and including a bottom portion having two or more openings formed therein, two or more sleeves engaged into the chamber of the housing and each including a bore aligned with the openings of the housing for receiving and engaging with inflation valves respectively, the sleeves being compressible and deformable to grasp and to secure the inflation valves to the housing, a mobile member slidably engaged in the chamber of the housing and including two or more compartments for slidably receiving and engaging with the sleeves and for selectively compressing the sleeves, two or more valve elements slidably engaged into the compartments of the mobile member and engaged into the bores of the sleeves for selectively engaging with the inflation valves respectively, a casing slidably engaged in the chamber of the housing and including a conduit formed therein for receiving a pressurized air, and including two or more spaces communicating with the conduit of the casing for slidably receiving and engaging with the valve elements respectively, the casing being slidable and movable relative to the housing for engaging with the mobile member and for selectively forcing the mobile member to compress the sleeves and to grasp and secure the inflation valves to the housing, and a spring biasing device for biasing the valve elements to engage with the mobile member and to prevent the pressurized air from flowing into the mobile member, and the inflation valves engaged onto either of the bores of the sleeves are engageable with either of the valve elements for disengaging either of the valve elements from the mobile member and for allowing the pressurized air to selectively flow into the compartments of the mobile member when the mobile member and the sleeves are compressed by the casing.

The mobile member includes two or more hubs extended therefrom and having the compartments formed in the hubs for slidably receiving and engaging with the valve elements respectively.

The mobile member includes a peripheral groove formed in each of the hubs for receiving and engaging with a sealing ring which makes an air tight seal between the casing and the hubs of the mobile member.

The valve elements each include a sealing ring for sealingly engaging with or blocking the hubs of the mobile member and for preventing the pressurized air from flowing into the hubs of the mobile member.

The valve elements each include a valve portion for selectively engaging with the hubs of the mobile member and for selectively blocking and sealing the compartments of the mobile member respectively.

The valve elements each include a projection extended therefrom and slidably engaged into the compartments of the mobile member and the bores of the sleeves for contacting and engaging with the inflation valves respectively.

The casing includes a passage formed therein and communicating with the conduit of the casing for allowing the pressurized air to selectively flow from the conduit through the passage and to flow out of the casing. The casing includes a relief valve engaged into the passage of the casing for selectively relieving the pressurized air to flow out through the passage of the casing.

The relief valve includes a valve piece slidably engaged in the passage of the casing for selectively engaging with a valve seat of the casing and for selectively blocking the passage of the casing. The relief valve includes a sealing ring attached to the valve piece for sealingly engaging with the valve seat of the casing.

The relief valve includes a spring biasing member engaged into the passage of the casing and engaged between the valve piece and the casing for biasing and forcing the valve piece away from the valve seat of the casing.

An actuating handle is further provided and pivotally attached to the housing with an axle and engaged with the casing for selectively moving and forcing the casing and the mobile member to compress and deform the sleeves.

The casing includes a recess formed between two side walls, and the actuating handle includes a first end portion engaged into the recess of the casing. The casing includes a slot formed in each of the side walls for slidably receiving and engaging with the axle and for allowing the casing to slide relative to the housing.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a partial exploded view of a pump connector device in accordance with the present invention, as seen from the upper portion of the pump connector device;

FIG. 2 is a further partial exploded view of the pump connector device as seen from the lower or bottom portion of the pump connector device;

FIG. 3 is a perspective view of the pump connector device;

FIG. 4 is a cross sectional view of the pump connector device taken along lines 4-4 of FIG. 3;

FIGS. 5, 6 are cross sectional views similar to FIG. 4, illustrating the operation of the pump connector device;

FIG. 7 is a further cross sectional view similar to FIGS. 4-6, illustrating the other application or arrangement of the pump connector device;

FIG. 8 is a still further cross sectional view similar to FIGS. 4-7, illustrating the further application or arrangement of the pump connector device; and

FIG. 9 is a still further cross sectional view similar to FIGS. 4-8, illustrating the still further application or arrangement of the pump connector device.

### DETAILED DESCRIPTION OF THE PREFERRED EMBODIMENT

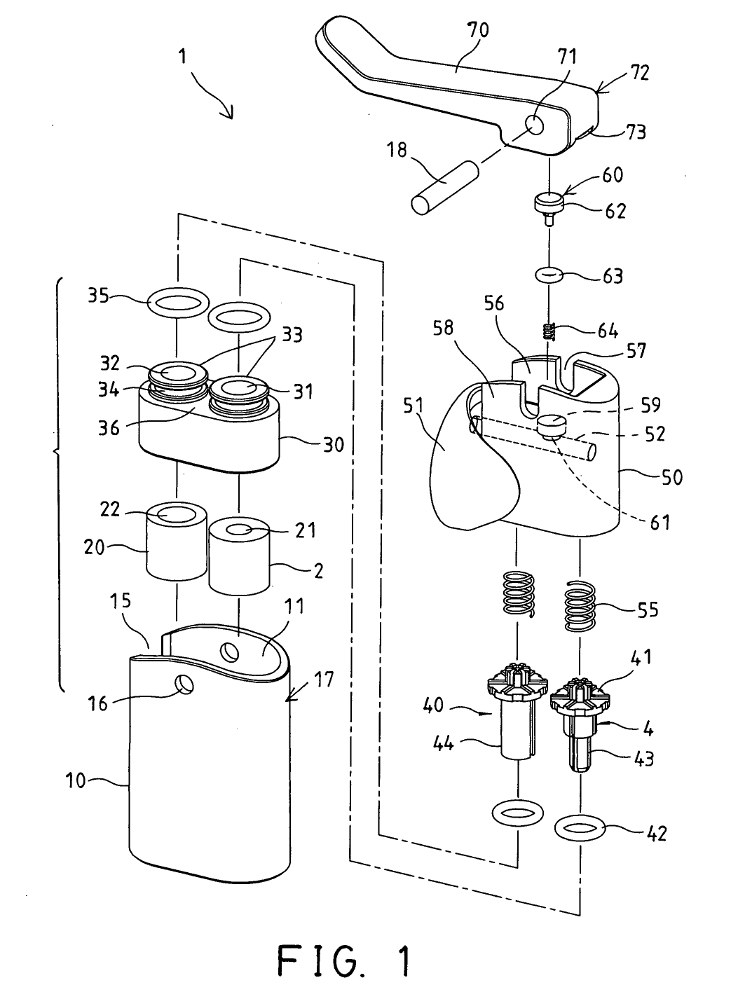

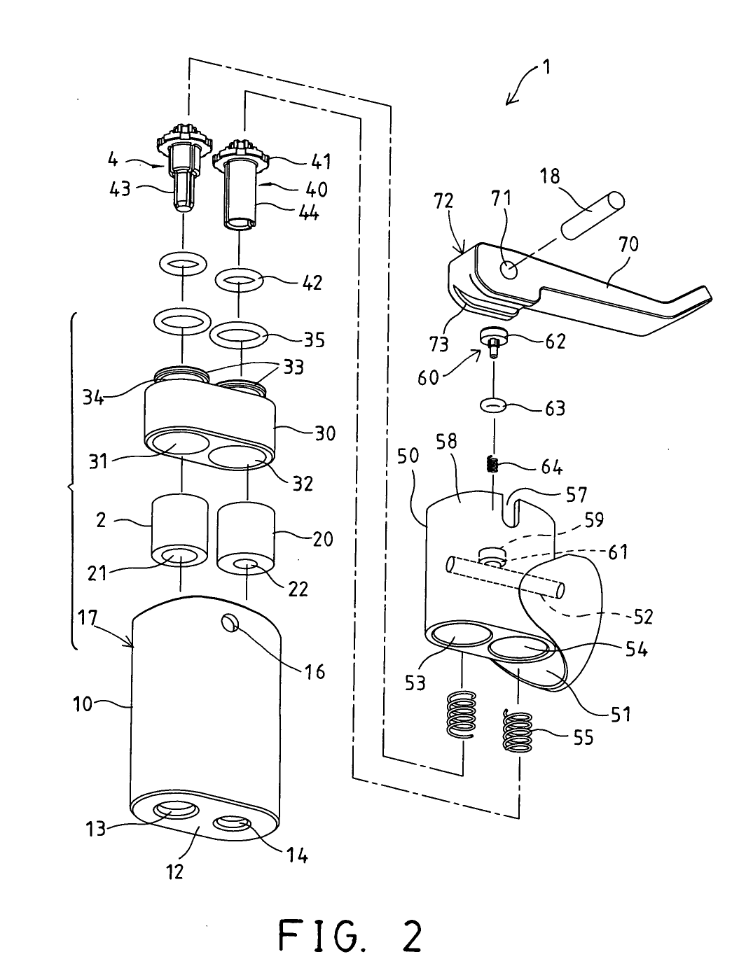

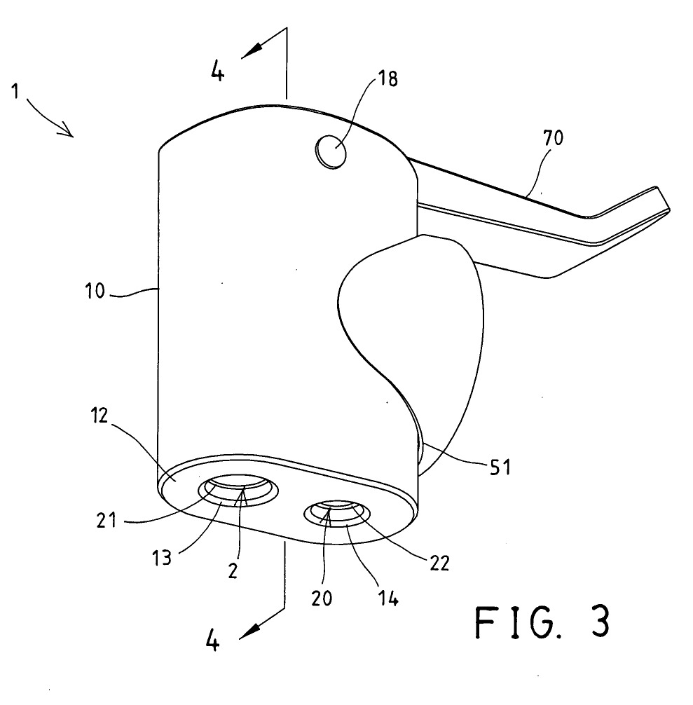

Referring to the drawings, and initially to FIGS. 1-3, a pump connector device 1 in accordance with the present invention comprises a head body or housing 10 including a chamber 11 formed therein, and including a bottom plate or portion 12 having two or more openings 13, 14 formed therein, and including a notch 15 formed in one side of the housing 10 (FIG. 1) and communicating with the chamber 11 of the housing 10, and including a lateral orifice 16 formed therein, such as formed in the upper portion 17 of the housing 10 for receiving or engaging with an axle 18 which is laterally extended through the chamber 11 of the housing 10. It is preferable, but not necessarily that the openings 13, 14 in the bottom portion 12 of the housing 10 may include different inner diameters.

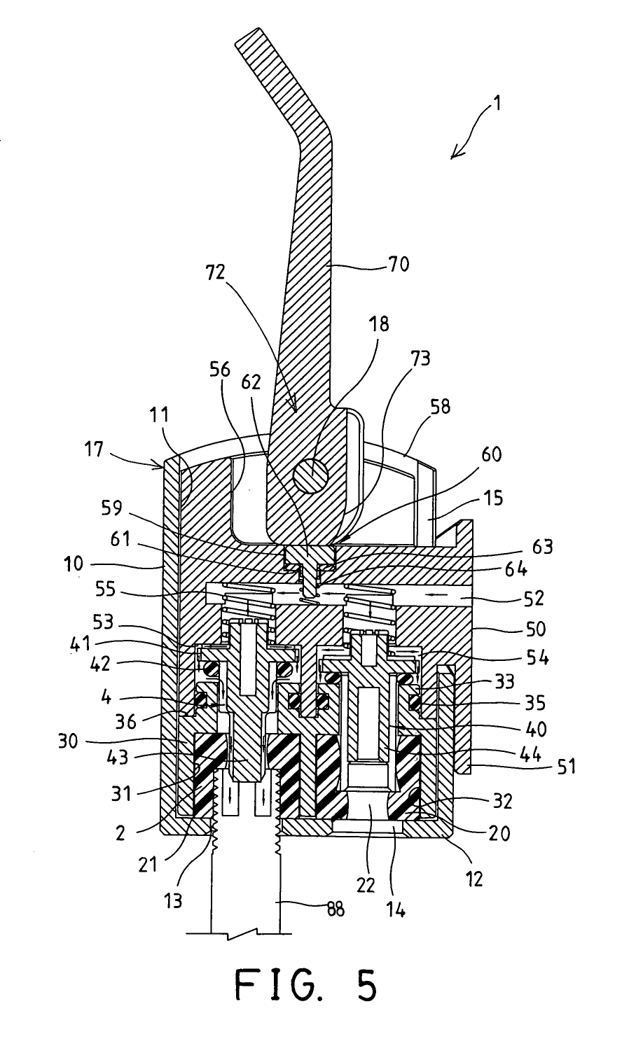

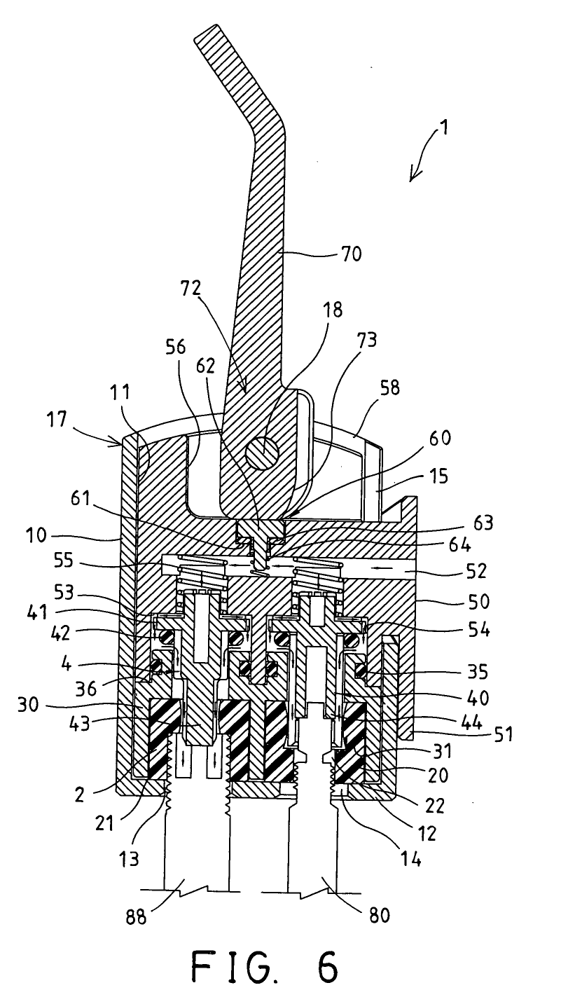

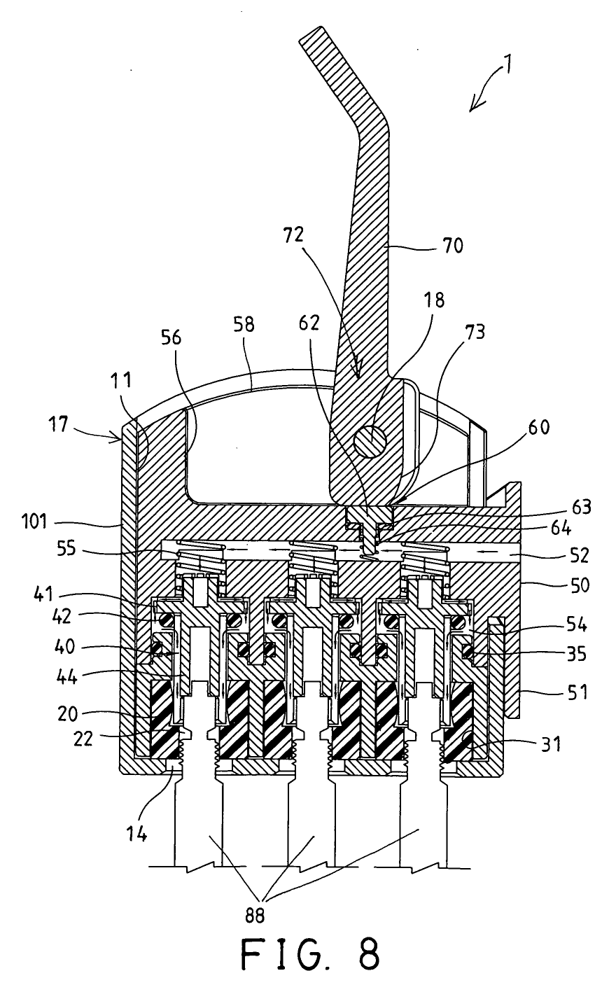

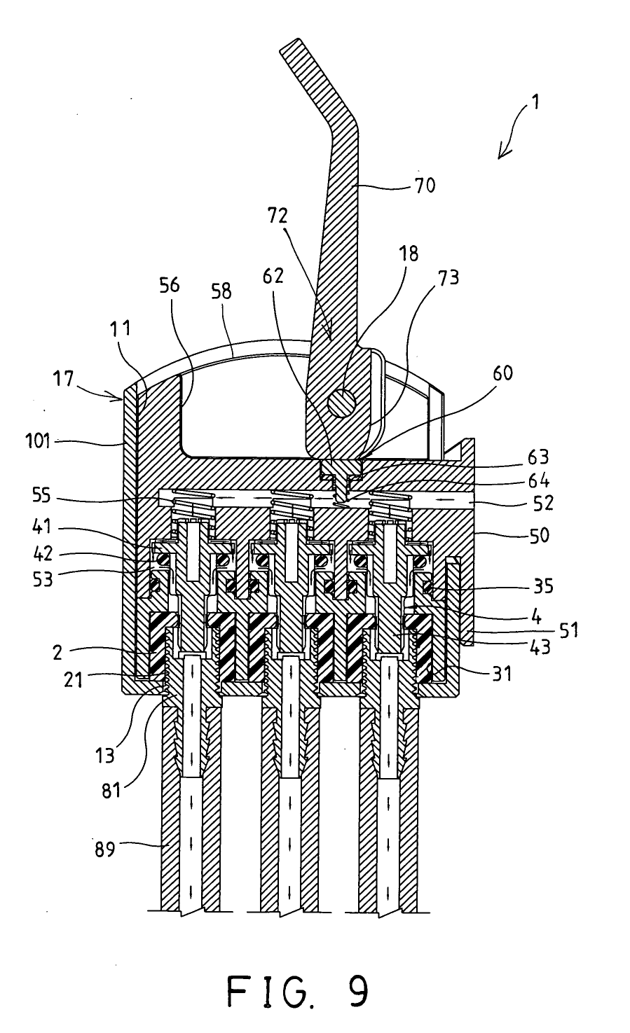

Two or more sleeves 2, 20 are engaged into the chamber 11 of the housing 10 and each include a bore 21, 22 formed therein and aligned with the openings 13, 14 of the bottom portion 12 of the housing 10 respectively for selectively receiving and engaging with the inflation valves 80, 88, such as the U.S. type valve 88 (FIGS. 5-7), the French type valve 80 (FIGS. 6, 8) and/or other nozzles 81 (FIG. 9), and the sleeves 2, 20 are made of soft or elastic materials, such as rubber, plastic or other synthetic materials for resiliently grasping the inflation valves 80, 88 and/or the nozzles 81. For example, when the sleeves 2, 20 are compressed by the other objects or members, the sleeves 2, 20 may be suitably deformed to resiliently grasp the inflation valves 80, 88 in order to stably or solidly anchor or secure the inflation valves 80, 88 to the housing 10.

A mobile member 30 is slidably engaged in the chamber 11 of the housing 10 and contains two compartments 31, 32 formed therein for slidably receiving or engaging with the sleeves 2, 20 respectively, and for anchoring or positioning the sleeves 2, 20 between the housing 10 and the mobile member 30, and for allowing the sleeves 2, 20 to be selectively compressed by the mobile member 30 and to be selectively deformed to resiliently grasp the inflation valves 80, 88 in order to stably or solidly anchor or secure the inflation valves 80, 88 to the housing 10. The mobile member 30 includes two ring members or hubs 33 extended upwardly from an upper plate 36 and having the compartments 31, 32 formed therein respectively, and each having a peripheral groove 34 formed in the outer peripheral portion thereof for receiving or engaging with a sealing ring 35.

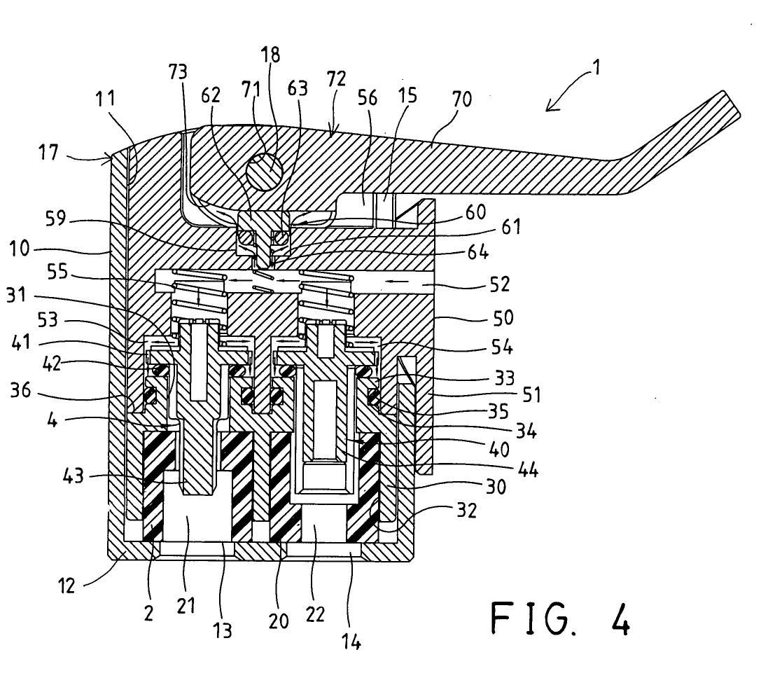

Two or more valve elements 4, 40 are slidably engaged into the compartments 31, 32 of the mobile member 30 and the bores 21, 22 of the sleeves 2, 20 respectively, and each include an enlarged head or valve portion 41 for selectively engaging with the hubs 33 or the mobile member 30 and for selectively blocking or sealing the compartments 31, 32 of the mobile member 30 respectively, and two sealing rings 42 may be engaged with the valve elements 4, 40 respectively and engaged with the valve portions 41 for sealingly engaging with the hubs 33 or the mobile member 30 (FIG. 4) and for preventing the pressurized air from flowing into the hubs 33 and the mobile member 30. The valve elements 4, 40 each include a needle or valve engaging piece or projection 43, 44 extended downwardly therefrom and slidably engaged into the compartments 31, 32 of the mobile member 30 and the bores 21, 22 of the sleeves 2, 20 for contacting or engaging with the inflation valves 80, 88 or the nozzles 81 respectively (FIGS. 5-9).

A follower or casing 50 is also slidably engaged into the chamber 11 of the housing 10, and includes a guide member 51 laterally extended from the casing 50 and slidably engaged with the notch 15 of the housing 10 for guiding the casing 50 to stably slide relative or along the housing 10, and includes a conduit 52 laterally formed in the casing 50 for connecting to the hand pump or air pump that may not be seen in the drawings, and includes two spaces 53, 54 formed in the casing 50 and communicating with the conduit 52 of the casing 50 for slidably receiving or engaging with the valve elements 4, 40 and the hubs 33 of the mobile member 30 respectively, and for engaging with the upper plate 36 of the mobile member 30 and thus for selectively forcing the mobile member 30 to compress the sleeves 2, 20 (FIGS. 5-9) and to resiliently grasp and secure the inflation valves 80, 88 to the housing 10. The casing 50 is slidably engaged with the sealing ring 35 for making an air tight seal between the casing 50 and the hubs 33 or the mobile member 30.

Two or more spring biasing means or members 55 are engaged into the spaces 53, 54 of the casing 50 and engaged with or between the casing 50 and the valve elements 4, 40 for biasing the valve portions 41 and/or the sealing rings 42 of the valve elements 4, 40 to sealingly engage with the hubs 33 or the mobile member 30 and to prevent the pressurized air from flowing into the hubs 33 and the mobile member 30 (FIG. 4). The valve portions 41 and/or the sealing rings 42 of the valve elements 4, 40 may be disengaged from the hubs 33 or the mobile member 30 (FIGS. 5-9) for allowing the pressurized air to selectively flow into the hubs 33 and the mobile member 30 when the inflation valves 80, 88 and/or the nozzles 81 are engaged into the bores 21, 22 of the sleeves 2, 20 and engaged with the projections 43, 44 of the valve elements 4, 40 for forcing the valve elements 4, 40 toward the casing 50 by depressing the spring members 55.

The casing 50 includes a recess 56 formed in the upper portion thereof and formed or defined by two opposite side walls 58, and includes a channel or slot 57 formed in each of the side walls 58 for slidably receiving or engaging with the axle 18 relatively and for allowing the casing 50 to slide relative to the housing 10 and also for limiting the casing 50 to slide relative to the housing 10, and includes a passage 59 formed therein and located between the recess 56 and the conduit 52 of the casing 50 and communicating with the recess 56 and the conduit 52 of the casing 50 for allowing the pressurized air to selectively flow from the conduit 52 through the passage 59 and into the recess 56 of the casing 50 and to selectively flow out of the casing 50 (FIG. 4).

A relief valve 60 is engaged into the passage 59 of the casing 50 for selectively relieving the pressurized air out through the passage 59 and the recess 56 of the casing 50, and includes a valve piece 62 slidably engaged in the passage 59 of the casing 50 for selectively engaging with the valve seat 61 of the casing 50 (FIGS. 1-2 and 4-5) and for selectively blocking (FIGS. 5-9) or opening (FIG. 4) the passage 59 of the casing 50 and for controlling the pressurized air to flow through the passage 59 of the casing 50. A sealing ring 63 may be engaged onto or with the valve piece 62 for selectively and sealingly engaging with the valve seat 61 of the casing 50, and another spring biasing member 64 may further be provided and engaged into the passage 59 of the casing 50 and engaged between the valve piece 62 and the valve seat 61 or the casing 50 for biasing or forcing the valve piece 62 away from the valve seat 61 of the casing 50 (FIG. 4).

An actuating handle 70 includes an aperture 71 formed therein, such as formed in the one end portion 72 thereof which is engaged into the recess 56 of the casing 50 for receiving or engaging with the axle 18 and for pivotally or rotatably attaching or securing the actuating handle 70 to the housing 10 and for allowing the actuating handle 70 to be rotated relative to the housing 10 to selected angular positions. The actuating handle 70 includes a cam member 73 formed or provided on the one end portion 72 thereof for engaging with the valve piece 62 of the relief valve 60 for selectively forcing the valve piece 62 of the relief valve 60 to engage with the valve seat 61 of the casing 50 (FIGS. 5-9) and for selectively blocking or opening the passage 59 of the casing 50 (FIGS. 4-9). The cam member 73 of the actuating handle 70 may also be engaged with the casing 50 for selectively moving or forcing the casing 50 and the mobile member 30 to selectively compress and deform the sleeves 2, and to resiliently grasp or secure the inflation valves 80, 88 to the housing 10.

In operation, as shown in FIG. 4, when no inflation valves 80, 88 and/or nozzles 81 are engaged into the bores 21, 22 of the sleeves 2, 20 and contacted and engaged with the projections 43, 44 of the valve elements 4, 40, the spring members 55 may bias the valve portions 41 and/or the sealing rings 42 of the valve elements 4, 40 to sealingly engage with the hubs 33 or the mobile member 30 and to prevent the pressurized air from flowing into the hubs 33 and the mobile member 30. At this moment, the pressurized air may selectively flow from the conduit 52 through the passage 59 and into the recess 56 of the casing 50 and to selectively flow out of the casing 50 or to be relieved when the valve piece 62 is not forced to engage with the valve seat 61 of the casing 50 and not to block the passage 59 of the casing 50.

As shown in FIGS. 5 and 6, when either or both of the inflation valves 80, 88 and/or nozzles 81 are engaged into the bores 21, 22 of the sleeves 2, 20 and contacted and engaged with the projections 43, 44 of the valve elements 4, 40, the inflation valves 80, 88 and/or nozzles 81 may move and force the valve elements 4, 40 toward the casing 50 and may depress the spring members 55, and the casing 50 and the mobile member 30 may then be selectively moved or forced by the cam member 73 of the actuating handle 70 to compress and deform the sleeves 2, 20 and to resiliently grasp or secure the inflation valves 80, 88 to the housing 10, and to disengage the valve portions 41 and/or the sealing rings 42 of the valve elements 4, 40 from the hubs 33 or the mobile member 30 and thus for allowing the pressurized air to selectively flow from the conduit 52 through the spaces 53, 54 of the casing 50 and into the hubs 33 and the mobile member 30, and thus for allowing the pressurized air to be selectively supplied to either or all of the inflation valves 80, 88 and/or nozzles 81.

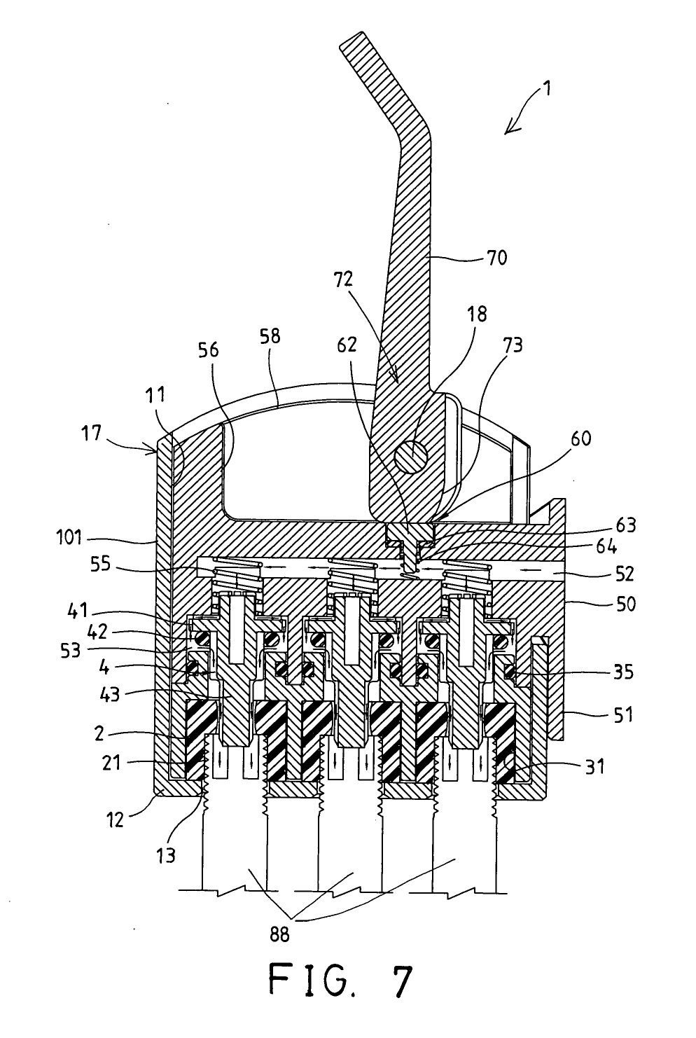

Alternatively, as shown in FIG. 7, the housing 101 may include a greater chamber 11 for receiving three or more sleeves 2 and three or more valve elements 4 for receiving or engaging with three or more U.S. type inflation valve 88; or as shown in FIG. 8, the housing 101 may include a greater chamber 11 for receiving three or more sleeves 20 and three or more valve elements 40 for receiving or engaging with three or more French type inflation valves 80; or as shown in FIG. 9, the housing 101 may also include a greater chamber 11 for receiving three or more sleeves 2 and three or more valve elements 4 for receiving or engaging with three or more nozzles 81 which may be coupled to hoses 89 for coupling to various pneumatic facilities or systems (not shown) and for allowing the pump connector device 1 to be formed or acted as a pressurized air or pneumatic control device.

Accordingly, the pump connector device in accordance with the present invention includes a simplified structure for easily connecting to different inflation valves of U.S. type and French type valves and/or the other nozzles and for being easily operated with or by the users.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A pump connector device comprising:
a housing including a chamber formed therein, and including a bottom portion having a first opening and at least one second opening formed therein,
a first sleeve and at least one second sleeve engaged into said chamber of said housing and each including a bore formed therein and aligned with said first and said at least one second openings of said housing for receiving and engaging with inflation valves respectively, said first and said at least one second sleeves being compressible and deformable to grasp and to secure the inflation valves to said housing,
a mobile member slidably engaged in said chamber of said housing and including a first compartment and at least one second compartment formed therein for slidably receiving and engaging with said first and said at least one second sleeves and for selectively compressing said first and said at least one second sleeves,
a first valve element and at least one second valve element slidably engaged into said first and said at least one second compartments of said mobile member and engaged into said bores of said first and said at least one second sleeves for selectively engaging with the inflation valves respectively,
a casing slidably engaged in said chamber of said housing and including a conduit formed therein for receiving a pressurized air, and including a first space and at least one second space formed therein and communicating with said conduit of said casing for slidably receiving and engaging with said first and said at least one second valve elements respectively, said casing being slidable and movable relative to said housing for engaging with said mobile member and for selectively forcing said mobile member to compress said first and said at least one second sleeves and to grasp and secure the inflation valves to said housing, and
spring biasing means for biasing said first and said at least one second valve elements to engage with said mobile member and to prevent the pressurized air from flowing into said mobile member, and
the inflation valves engaged onto either of said bores of said first and said at least one second sleeves being engageable with either of said first and said at least one second valve elements for disengaging either of said first and said at least one second valve elements from said mobile member and for allowing the pressurized air to selectively flow into said first and said at least one second compartments of said mobile member when said mobile member and said first and said at least one second sleeves are compressed by said casing.

2. The pump connector device as claimed in claim 1, wherein said mobile member includes a first hub and at least one second hub extended therefrom and having said first and said at least one second compartments formed therein for slidably receiving and engaging with said first and said at least one second valve elements respectively.

3. The pump connector device as claimed in claim 2, wherein said mobile member includes a peripheral groove formed in each of said first and said at least one second hubs for receiving and engaging with a sealing ring which makes an air tight seal between said casing and said first and said at least one second hubs of said mobile member.

4. The pump connector device as claimed in claim 2, wherein said first and said at least one second valve elements each include a sealing ring for sealingly engaging with said first and said at least one second hubs of said mobile member and for preventing the pressurized air from flowing into said first and said at least one second hubs of said mobile member.

5. The pump connector device as claimed in claim 1, wherein said first and said at least one second valve elements each include a valve portion for selectively engaging with said first and said at least one second hubs of said mobile member and for selectively blocking and sealing said first and said at least one second compartments of said mobile member respectively.

6. The pump connector device as claimed in claim 1, wherein said first and said at least one second valve elements each include a projection extended therefrom and slidably engaged into said first and said at least one second compartments of said mobile member and said bores of said first and said at least one second sleeves for contacting and engaging with the inflation valves respectively.

7. The pump connector device as claimed in claim 1, wherein said casing includes a passage formed therein and communicating with said conduit of said casing for allowing the pressurized air to selectively flow from said conduit through said passage and to flow out of said casing.

8. The pump connector device as claimed in claim 7, wherein said casing includes a relief valve engaged into said passage of said casing for selectively relieving the pressurized air out through said passage of said casing.

9. The pump connector device as claimed in claim 8, wherein said relief valve includes a valve piece slidably engaged in said passage of said casing for selectively engaging with a valve seat of said casing and for selectively blocking said passage of said casing.

10. The pump connector device as claimed in claim 9, wherein said relief valve includes a sealing ring attached to said valve piece for sealingly engaging with said valve seat of said casing.

11. The pump connector device as claimed in claim 9, wherein said relief valve includes a spring biasing member engaged into said passage of said casing and engaged between said valve piece and said casing for biasing and forcing said valve piece away from said valve seat of said casing.

12. The pump connector device as claimed in claim 1 further comprising an actuating handle pivotally attached to said housing with an axle and engaged with said casing for selectively moving and forcing said casing and said mobile member to compress and deform said first and said at least one second sleeves.

13. The pump connector device as claimed in claim 12, wherein said casing includes a recess formed between two side walls, and a slot formed in each of said side walls for slidably receiving and engaging with said axle and for allowing said casing to slide relative to said housing.
